(19) United States
(12) Patent Application Publication
(10) Pub. No.: US 2025/0175955 A1
(43) Pub. Date: May 29, 2025

(54) DATA TRANSMISSION METHOD, DEVICE AND SYSTEM

(71) Applicant: Douyin Vision Co., Ltd., Beijing (CN)

(72) Inventors: Qianghua LIU, Beijing (CN); Jianping CHEN, Beijing (CN); Yongyi YU, Beijing (CN); Tianyi LIU, Beijing (CN)

(21) Appl. No.: 19/037,048

(22) Filed: Jan. 24, 2025

Related U.S. Application Data
(63) Continuation of application No. PCT/CN2023/109114, filed on Jul. 25, 2023.

(30) Foreign Application Priority Data
Jul. 26, 2022 (WO) PCT/CN2022/107962

(51) Int. Cl. H04W 72/0446; H04L 69/164; H04W 76/10

(52) U.S. Cl. CPC H04W 72/0446; H04L 69/164; H04W 76/10

(57) ABSTRACT

The present disclosure relates to the technical field of communications, and relates to a data transmission method, device and system. The data transmission method includes: establishing a connection to a receiving end of data to be transmitted; and sending to the receiving end at least one of an expiration offset frame used for indicating data which is not retransmitted and is among the data to be transmitted, a boundary frame used for indicating the boundary position of a data block in a data stream of the data to be transmitted, and a related frame used for associating a plurality of data streams of the data to be transmitted which are created on the basis of the same request, such that the receiving end transmits, according to at least one of the expiration offset frame, the boundary frame and the related frame, the data to be transmitted.

### CROSS REFERENCE TO RELATED APPLICATIONS

The present application is a continuation of International Patent Application No. PCT/CN2023/109114, filed on Jul. 25, 2023, which is based on and claims priority to PCT Application No. PCT/CN2022/107962 filed on Jul. 26, 2022, the disclosures of which are incorporated by reference herein in their entireties.

### TECHNICAL FIELD

The present disclosure relates to the field of communication technology, in particular to a data transmission method, a data transmission device, a data transmission system, a nonvolatile computer-readable storage medium, a computer program and a computer program product.

### BACKGROUND

In the related art, the QUIC (Quick UDP Internet Connection) transmission protocol is a secure general transmission protocol, which provides a reliable multi-stream connection for a data transmission of an application program. The QUIC transmission protocol may use a plurality of streams to send data, which is referred to as a multi-stream transmission function. The QUIC transmission protocol is usually applied in a full duplex mode, in which the device may be either a sender or a receiver. The server and the client may both create streams, which are independent of each other, and may also assign a transmission priority.

### SUMMARY

According to some embodiments of the present disclosure, a data transmission method is provided. The method comprises: a sender sending at least one of an expire offset frame for indicating data not required to be repeatedly transmitted, a boundary frame for indicating an independent data block, or a correlation frame for correlating a plurality of data streams of the same request to a receiver, so that the receiver transmits data according to at least one of the expire offset frame, the boundary frame or the correlation frame.

According to some embodiments of the present disclosure, a data transmission method on a sender side is provided. The method comprises: establishing a connection with a receiver of data to be transmitted; and sending at least one of an expire offset frame for indicating data that is not retransmitted of data to be transmitted, a boundary frame for indicating a boundary position of a data block in a data stream of data to be transmitted, or a correlation frame for associating a plurality of data streams created based on the same request in data to be transmitted to the receiver, so that the receiver transmits the data to be transmitted according to at least one of the expire offset frame, the boundary frame or the correlation frame.

According to other embodiments of the present disclosure, a data transmission method is provided. The method comprises: a receiver receiving at least one of an expire offset frame for indicating data not required to be repeatedly transmitted, a boundary frame for indicating an independent data block, or a correlation frame for correlating a plurality of data streams of the same request sent by a sender; and the receiver perform a data transmission according to at least one of the expire offset frame, the boundary frame or the correlation frame.

According to some embodiments of the present disclosure, another data transmission method on a receiver side is provided. The method comprises: establishing a connection with a sender of data to be transmitted; receiving at least one of an expire offset frame for indicating data that is not retransmitted of the data to be transmitted, a boundary frame for indicating a boundary position of a data block in a data stream of the data to be transmitted, or a correlation frame for associating a plurality of data streams created based on a same request of the data to be transmitted that is transmitted by the sender; and transmitting the data to be transmitted according to at least one of the expire offset frame, the boundary frame or the correlation frame.

According to still other embodiments of the present disclosure, a data transmission device arranged at a sender is provided. The device comprises: a sending unit configured to send at least one of an expire offset frame for indicating data not required to be repeatedly transmitted, a boundary frame for indicating an independent data block, or a correlation frame for correlating a plurality of data streams of the same request by a sender to a receiver, so that the receiver transmits data according to at least one of the expire offset frame, the boundary frame or the correlation frame.

According to still other embodiments of the present disclosure, a data transmission device arranged at a sender is provided. The device comprises: a connection unit for establishing a connection with a receiver of data to be transmitted; and a sending unit for sending at least one of an expire offset frame for indicating data that is not retransmitted of the data to be transmitted, a boundary frame for indicating a boundary position of a data block in a data stream of the data to be transmitted, or a correlation frame for associating a plurality of data streams created based on a same request of the data to be transmitted to the receiver, to allow the receiver to transmit the data to be transmitted according to the at least one of the expire offset frame, the boundary frame or the correlation frame.

According to yet other embodiments of the present disclosure, a data transmission device arranged at a receiver is provided. The device comprises: a receiving unit configured to receive at least one of an expire offset frame for indicating data not required to be repeatedly transmitted, a boundary frame for indicating an independent data block, or a correlation frame for correlating a plurality of data streams of the same request sent by a sender; and a transmitting unit configured to transmit data according to at least one of the expire offset frame, the boundary frame or the correlation frame.

The data transmission device arranged at a receiver comprises: a connection unit for establishing a connection with a sender of data to be transmitted; a receiving unit for receiving at least one of an expire offset frame for indicating data that is not retransmitted of the data to be transmitted, a boundary frame for indicating a boundary position of a data block in a data stream of the data to be transmitted, or a correlation frame for associating a plurality of data streams created based on a same request of the data to be transmitted that is transmitted by the sender; and a transmitting unit for transmitting the data to be transmitted according to at least one of the expire offset frame, the boundary frame or the correlation frame.

According to still other embodiments of the present disclosure, a data transmission system is provided. The data transmission system comprises: a sender for performing a transmission method on a sender side according to any of the above-described embodiments; and a receiver for performing a transmission method on a receiver side according to any of the above-described embodiments.

According to still other embodiments of the present disclosure, a data transmission device is provided. The data transmission device comprises: a memory; and a processor coupled to the memory, wherein the processor is configured to perform the data transmission method according to any of the above-described embodiments based on instructions stored in the memory device.

According to still other embodiments of the present disclosure, a nonvolatile computer-readable storage medium is provided. The computer-readable storage medium has a computer program stored thereon that, when executed by a processor, implements the data transmission method according to any some of the above-described embodiments.

According to some embodiments of the present disclosure, a computer program is also provided. The computer program comprises: instructions that, when executed by a processor, cause the processor to perform the data transmission method according to any of the above-described embodiments.

According to some embodiments of the present disclosure, a computer program product is also provided. The computer program product comprises instructions that, when executed by a processor, cause the processor to perform the data transmission method according to any of the above-described embodiments.

Other features and advantages of the present disclosure will become explicit from the following detailed description of exemplary embodiments of the present disclosure with reference to the accompanying drawings.

### BRIEF DESCRIPTION OF THE DRAWINGS

The accompanying drawings described here which are intended to provide a further understanding of the present disclosure, constitute a part of the present application. The illustrative embodiments of the present disclosure as well as the descriptions thereof, which are intended for explaining the present disclosure, do not constitute improper definitions on the present disclosure. In the accompanying drawings:

FIGS. 1a to 1b show flowcharts of some embodiments of a data transmission method according to the present disclosure;

FIGS. 2a to 2c show schematic views of some embodiments of a frame structure according to the present disclosure;

FIG. 3 shows a schematic view of some embodiments of a data transmission method according to the present disclosure;

FIGS. 4a to 4b show block diagrams of some embodiments according to a data transmission device of the present disclosure;

FIG. 5 shows a block diagram of other embodiments of a data transmission device according to the present disclosure;

FIG. 6 shows a block diagram of still other embodiments of a data transmission device according to the present disclosure;

FIG. 7 shows a block diagram of some embodiments of a data transmission system according to the present disclosure;

FIGS. 8a to 8e show schematic views of other embodiments of a data transmission method according to the present disclosure.

### DETAILED DESCRIPTION

The technical solutions in the embodiments of the present disclosure will be explicitly and completely described below in conjunction with the accompanying drawings in the embodiments of the present disclosure. Apparently, the embodiments described are merely some of the embodiments of the present disclosure, rather than all of the embodiments. The following descriptions of at least one exemplary embodiment which are in fact merely illustrative, shall by no means serve as any delimitation on the present disclosure as well as its application or use. On the basis of the embodiments of the present disclosure, all the other embodiments obtained by those of ordinary skill in the art on the premise that no inventive effort is involved shall fall into the protection scope of the present disclosure.

The relative arrangements, numerical expressions and numerical values of the components and steps elaborated in these examples shall not limit the scope of the present invention unless specified otherwise. At the same time, it should be understood that, for ease of description, the dimensions of various parts shown in the accompanying drawings are not drawn according to actual proportional relations. The techniques, methods, and devices known to those of ordinary skill in the relevant art might not be discussed in detail. However, the techniques, methods, and devices shall be considered as part of the granted description where appropriate. Among all the examples shown and discussed here, any specific value shall be construed as being merely exemplary, rather than as a restriction. Thus, other examples in the exemplary embodiments may have different values. It is to be noted that: similar reference numerals and letters present similar items in the following accompanying drawings, and therefore, once an item is defined in one accompanying drawing, a further discussion thereof is not required in subsequent accompanying drawings.

As described previously, some application programs with a high real-time requirement need a transmission layer protocol to provide a transmission priority related to data content, which avoids head-of-line blocking between priorities and makes an application layer unaware.

For example, in a stream media live streaming application with a high real-time requirement, if a segment of data with a low priority has always been retransmitted due to a packet loss, in order to ensure a real-time performance, the application prefers not to await this segment of data but continue to use new data generated. Since the delay from the audience end to the streamer end may be lengthened by continuing to await this segment of data, it is possible to affect the viewing experience of the user.

For this reason, some data that not be delivered over time may not be retransmitted but discarded. Although the delay may be effectively ensured by avoiding retransmission, the quality of data transmitted to the application layer is uncontrollable.

Although the QUIC transmission protocol has multiple functions, such as ORTT (Round-Trip Time) connection establishment (ORTT means that the first data packet may carry effective service data in response to two communication parties initiating a communication connection), congestion control, link migration, safe and reliable transmission. Most UDP (User Datagram Protocol) application programs may be migrated to QUIC, but the current QUIC transmission protocol is still present with some technical problems in real-time communication scenarios.

For example, QUIC is a reliable transmission protocol, and the data transmitted in a stream may still be present with the technical problem of head-of-line blocking. This technical problem is relatively severe in a real-time stream.

In view of the above-described technical problem, it is possible to increase the support for unreliable datagrams sent and received through the QUIC connection to provide an extended QUIC (QUICU).

In some embodiments, the main frame format in this solution is as follows: the frame of a DATAGRAM type is configured to transmit application data in an unreliable manner; and the format of the ‘Type’ field in the DATAGRAM frame is Ob0011000X, and the values may be 0x30 and 0x31.

For example, the last bit of the ‘Type’ field is significant. It is a length identification (LEN) bit (0x01), which indicates whether there is a length field next. If the last bit of the ‘Type’ field is 0, it means that there is no length field, and the length of the whole message data will continue until the end of a packet. If the last bit of the ‘Type’ field is 1, it means that there is a length field.

For example, the DATAGRAM frame format is as follows:

DATAGRAM Frame {
Type (i)=0x30 . . . 0x31,
[Length (i)],
Datagram Data ( . . . ),}.

For example, the field contained in a DATAGRAM frame has the following semantic meaning. Length is an integer with a variable length, which presents a data content length of DATAGRAM in bytes. This field exists only when the LEN bit is 1. When LEN is 0, the data of DATAGRAM will continue into the whole QUIC packet. It is to be noted that, the length of the data content may be 0.

For example, Datagram Data is a data content required to be transmitted.

In some embodiments, the specification and usage of the technical solution in the above-described embodiments in the QUIC transmission protocol are as follows.

For example, when an application needs to send data through QUIC, QUIC may generate a new DATAGRAM frame, which is then sent out in the first available QUIC packet. This DATAGRAM frame will be sent out as soon as possible (actually depending on some actual conditions, for example, congestion control which will be introduced later). The DATAGRAM frame may also be combined together with other frames into a QUIC packet.

For example, when one QUIC terminal receives a DATAGRAM frame, as long as the application layer may process the DATAGRAM frame and has a memory to store it, it is necessary to return data to the application layer immediately. Similar to a Stream frame, the application layer data carried by the DATAGRAM frame needs to be protected with 0RTT key or 1RTT key.

Although the max_datagram_frame_size transmission parameter represents definition of a maximum value of a DATAGRAM, as a matter of fact, this limit may be reduced due to the max_udp_payload_size transmission parameter and the MTU (Maximum Transmission Unit) between end to end. The DATAGRAM frame cannot be split. Therefore, the application layer protocol needs to deal with the problem that the maximum value is affected by actual conditions.

For example, the DATAGRAM frame is to connect the whole QUIC connection, rather than to associate the QUIC layer with the stream. However, the application hopes to distinguish different DATAGRAM frames by different identifiers.

For example, the logical offload of the data packet is to distinguish different types of data packets. The identifier defining multi-streaming or logical offload is an obligation of the application layer using a QUIC protocol, and the application defines the syntax and parsing method of the data content. If the application needs to support a plurality of streams of data packets present at the same time, one method is to use a “lengthened” field at the beginning of the data content, which is a simple method allowing for encoding a large number of streams using minimum space. The QUIC implementation should provide an API to the application program to assign relative priorities between datagram frames and for QUIC streams.

Although the DATAGRAM frame may not be retransmitted during loss detection, they may trigger ACK (Acknowledgement), that is, ‘ACK excitation frame’. The receiving party should support delaying the ACK frame in response to receiving a data packet containing only a DATAGRAM frame. Because, if these DATAGRAMs are not acknowledged temporarily, the sending party will not take any action. Because the payload of the data packet is unknown to the receiving party, the receiving party will continue to send the ACK frame when the condition indicates that the data might be lost or max_ack_delay (Maximum ACK delay) or other components indicate that the DATAGRAM packet may be lost.

If the DATAGRAM is not transmitted together with other “ACK excitation frames” and the sender suspects that the DATAGRAM might have been lost, a probe packet is sent to trigger a faster ACK response. If the sender detects that the data packet containing the DATAGRAM frame is lost, it is necessary to send a notice to the application layer to inform the application layer that the data packet is lost.

If a data packet containing a DATAGRAM frame is acknowledged, it is also necessary to inform the application layer that the message has been successfully sent and received. Due to out-of-order, it is possible to lead to a circumstance that a data packet is acknowledged to have been lost but is then received and acknowledged. The acknowledgement to the DATAGRAM frame only represents that the transmission layer has received and processed it, but does not ensure that the application layer at a receiver has successfully processed the data. Therefore, this does not use ACK to replace a successful processing message of the application layer.

The DATAGRAM frame does not provide flow control signaling in display, and does not act on flow control of any QUIC stream level or QUIC connection level. The risk that the DATAGRAM frame does not provide flow control lies in that the receiver might not be available for enough resources to process the data. For example, the application does not have enough memory to store data. Nevertheless, because the DATAGRAM frame itself is unreliable, the receiver may discard the data when the data cannot be processed.

Since the DATAGRAM frame uses QUIC congestion control, the connection might not be able to send the DATAGRAM frame created by the application layer until data congestion control allows for transmitting the same. The sender has to await until the congestion control allows the same, or discard the data. If racing is used in the implementation, it is also possible to allow for a sending delay due to racing. In actual implementation, it is possible to support allowing an application program to set a sending timeout, which is a maximum time to delay transmitting a packet until data is discarded due to congestion control.

Even if the above-described technical solution is introduced into the QUIC transmission protocol, there is still present with a technical problem. In real-time transmission scenarios with a high bit rate, for example, audio and video transmission, comprising an application program of a virtual reality type, packet loss is sometimes inevitable.

On one hand, after packet loss is detected, a reliable transmission algorithm of QUIC will continue to retransmit the lost data until the data is successfully received. Although this ensures the reliability of data, it is also possible to increase the data transmission delay due to head-of-line blocking.

On the other hand, there is a technical problem of not performing any retransmission after packet loss, for example, by using a QUIC frame type of the data packet specified in the above-described technical solution. Although a delay may be effectively ensured when there is no retransmission, the quality of data transmitted to the application layer is uncontrollable. For example, audio might be intermittent, with frequent and sharp bursts, and a video image might often be blurred or unplayable.

Therefore, it is desirable to have a mechanism that allows for controlling the retransmitted data amount and the time range, thereby allowing an optimum trade-off between the delay and the media quality.

The present disclosure finds that there is the following problem in the above-described related technologies: a data transmission delay is increased. In view of this, the present disclosure provides a technical solution of data transmission.

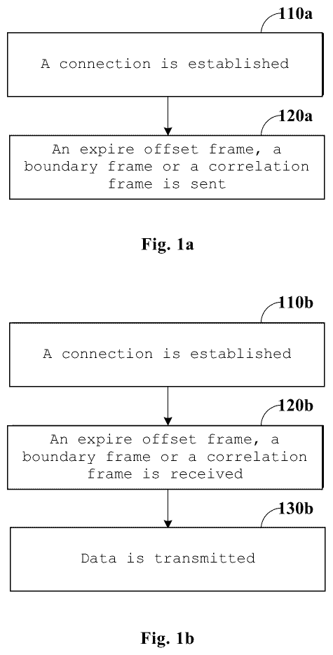

FIGS. 1a to 1b show flowcharts of some embodiments of a data transmission method according to the present disclosure.

As shown in FIG. 1a, in step 110a, a connection with a receiver of the data to be transmitted is established. For example, at least one of an expire offset frame for indicating data not required to be repeatedly transmitted, a boundary frame for indicating an independent data block, or a correlation frame for correlating a plurality of data streams of the same request is generated.

In some embodiments, the expire offset frame comprises a first offset for indicating that data before the first offset relative to the expire offset frame in the data stream of the data to be transmitted is not retransmitted.

In some embodiments, the boundary position comprises an ending position, and the boundary frame comprises a second offset for indicating the ending position of the data block.

In some embodiments, the boundary frame is configured to save, in response to a data segment comprised in the data block being lost and not retransmitted, related information of a transmission for the data segment, related information of a retransmission for the data segment or related information of a retransmission request for the data segment.

In some embodiments, the boundary frame is configured to assign a same transmission priority to a plurality of data segments comprised in the data block. For example, the same transmission priority is configured to indicate that in response to a part of data segments in the data block being lost and not retransmitted, another part of data segments in the data block is not retransmitted.

In step 120a, sending at least one of an expire offset frame for indicating data that is not retransmitted of data to be transmitted, a boundary frame for indicating a boundary position of a data block in a data stream of the data to be transmitted, or a correlation frame for associating a plurality of data streams created based on a same request of the data to be transmitted to the receiver, to allow the receiver to transmit the data to be transmitted according to the at least one of the expire offset frame, the boundary frame or the correlation frame.

In some embodiments, the correlation frame comprises a correlation stream ID, and each data stream of the plurality of data streams created based on the same request has a same correlation stream ID. For example, the plurality of data streams associated with the correlation frame are presented together.

In some embodiments, in response to the connection being established, it is determined whether the receiver supports an extended Quick UDP Internet Connection (QUICU) according to an identifier of the receiver. At least one of the expire offset frame, the boundary frame or the correlation frame is sent in response to the receiver supporting the QUICU.

As shown in FIG. 1b, in step 110b, a connection with a sender of data to be transmitted is established.

In step 120b, at least one of an expire offset frame for indicating data that is not retransmitted of data to be transmitted, a boundary frame for indicating a boundary position of a data block in a data stream of the data to be transmitted, or a correlation frame for associating a plurality of data streams created based on a same request of the data to be transmitted that is transmitted by the sender is received.

In step 130b, the data to be transmitted according to at least one of the expire offset frame, the boundary frame or the correlation frame is transmitted.

In some embodiments, transmitting an identifier to the sender, which is for identifying whether a receiver of the data to be transmitted supports an extended Quick UDP Internet Connection (QUICU), in response to the connection being established. At least one of the expire offset frame, the boundary frame or the correlation frame is sent in response to the receiver supporting the QUICU.

In some embodiments, the present disclosure provides a QUIC Unreliable Transport Protocol (QUICU), which is an extension of the QUICU protocol for transmitting unreliable data, with the purpose of reducing data transmission delay.

For example, the excellent transmission characteristics of QUIC (for example, retransmission, congestion control, multi-streaming and the like) are reused, and the characteristics of a data packet loss are added. By controlling the time and range of a packet loss, QUICU may reduce useless transmission to improve the transmission efficiency and reduce the line congestion to enhance the transmission timeliness, which is beneficial to a delay-sensitive application program, especially an audio and video application program.

In some embodiments, the present disclosure provides a mechanism that involves defining three new frame types, that is, Expire Offset Frame, Boundary Frame and Correlation Frame. Each of these frames carries a type field indicating a frame type and a stream ID of a current stream (the stream comprising the frame).

In some embodiments, each of the above-described frames comprises a special field as follow.

For example, the expire offset frame carries an offset of the data stream, for informing the receiver that the data before the offset in the data stream is not retransmitted. After the information above is received, the receiver does not await any data before the offset in the data stream.

For example, the boundary frame also carries an offset of the data stream, for indicating the ending of an independent data block in the data stream. All the data segments of one independent data block should be coupled in transmission. This is because the data segments are meaningful only if all the data segments of the same independent data block are successfully received. This information may be configured to save the transmission, the retransmission or a retransmission request of some data segments in the case where it is known that some data segments of the same independent block are lost and are not retransmitted.

For example, this information may also be configured to assign the same priority to all the data segments of an independent data block. For example, if some of the coded images are lost and not retransmitted, all the subsequent images in the same independent image group are also usually useless even if they are received. Since they usually depend on a previous image lost (or partial lost) for inter-frame prediction reference, in this case, the data transmission, the retransmission and the retransmission request of these images may be skipped.

For example, the correlation frame carries a correlation stream ID, which is a stream ID of the stream comprising a request on which a current stream is created, for correlating a plurality of streams created based on the same request. For the reason of backward compatibility, the stream system may store multi-streamed media content (for example, in a FLV format, that is, a Flash video format) in a source server and an edge server, and at the same time use QUIC to transmit a media component in a separate stream to take advantage of different priorities and other attributes of different media components.

For example, in this stream system, a plurality of streams may be created based on one request (a download request or an upload request). However, without additional information, the entities that receive these streams are not able to determine which received streams come from the same request. Therefore, correlation frames in these received streams should be presented together to provide such additional information; and those received streams with the same correlation stream ID value, come from the same request, and should be presented together.

The unreliable transmission method of the present disclosure may achieve a balance between the delay and the transmission quality. In the following, the solution is described in several aspects such as transmission negotiation, data sending, data receiving and data expiration, and some embodiments concerning the protocol are provided.

In some embodiments, during the transmission negotiation process, in response to a connection being established, it is necessary to use a QUICU identifier to confirm whether the receiver supports QUICU. The value of 0 for the QUICU identifier indicates that QUICU is not supported, and the value of 1 indicates that QUICU is supported.

For example, the QUICU identifier needs to be registered in IANA (Internet Assigned Numbers Authority Services), and needs to be carried through ALPN (Application-Layer Protocol Negotiation) to indicate whether the QUICU protocol is supported. If the QUICU identifier is not present, the value is inferred to be equal to 0.

In some embodiments, during the transmission negotiation process, in response to a connection being established, a bidirectional stream may be established like a common QUIC. Before the boundary frame is received, the receiver may respond to data like a common QUICU stream, and start to enter a QUICU mode after the boundary frame is received.

In some embodiments, if the QUICU identifier of a peer is not received during the handshake negotiation, the boundary frame, the correlation frame and the expire offset frame cannot be sent to the peer. If one party which does not carry the QUICU identifier receives a QUICU-specific frame from a peer, the party should disconnect and indicate to the other party that the party does not support the QUICU protocol.

In some embodiments, after the stream establishes a QUICU mode, the QUICU mode is applied to the whole life cycle of the stream.

In some embodiments, the QUICU mode may be unidirectional. Receiving a boundary frame indicates that the incoming stream of the entity is in a QUICU mode. However, the outgoing stream of this entity may still be in a normal QUIC mode.

In some embodiments, during the data sending process, if different components of data are not required to be processed differently (for example, having the same priority) in transmission, the different components may be transmitted in the same stream. In this case, data is usually encapsulated in a stream frame, and the boundary frame may be configured to indicate a boundary between independent data blocks in the data stream.

In some embodiments, the starting and ending of an independent data block may be determined by two boundary frames. However, the first independent data block and the last independent data block are exceptions, wherein the starting position of the first independent data block is the starting of the data stream, and the ending position of the last independent data block is the ending of the data stream.

In some embodiments, if different components of data indeed need to be processed differently in transmission, for example, having different priorities, the different components should be transmitted in different streams. In this case, it is necessary to transmit the correlation frame to the correlation stream created based on the same request.

In some embodiments, the method of dividing data blocks comprises dividing according to a length of data each time the user calls a write interface.

In some embodiments, the packetization comprises making the Boundary Frame and the first byte of a corresponding data block in the same QUIC packet, which facilitates the retransmission of the Boundary Frame.

In some embodiments, if it is necessary to distinguish priorities, a priority may be set at the interface. For example, the QUIC protocol stack creates different Streams for different priorities, which are not perceptible to an application. The Correlation Frame is required to be sent, wherein the Stream ID is an ID that initiates a request, and the Correlation ID is an ID corresponding to the Stream created by the protocol stack itself. For example, in the same request, there is only one stream ID, but there may be a plurality of Correlation ID.

In some embodiments, during the data receiving process, in a data stream, if a Boundary frame is not received, a common QUIC mode is still used, and otherwise a QUICU mode is entered.

In some embodiments, in the QUICU mode, the data in each Boundary frame is delivered to the application layer in sequence, and the minimum delivery unit is a Boundary frame, that is, the data of the whole Boundary frame is received in sequence before the whole Boundary frame is delivered to the application. However, if the data of a Boundary frame expires, the data of another Boundary frame after the Boundary frame may be continued to be delivered to the application layer.

In other words, in the QUICU mode, callback is made in the unit of a boundary frame, that is, a data callback may be made once each time a continuous stream offset which is greater than or equal to the first boundary offset is received. In response to a QUIC stream created by the other party being received, it is necessary to set the stream in a block state and await a correlation frame. After the correlation frame arrives, the QUIC stream created by the server is correlated with the QUIC stream created by the client, and a data callback is made in the unit of a boundary frame after correlation. If an Expired Frame is received, it means that the sender no longer retransmits the content before the Offset corresponding to the StreamID designated in the Expired Frame. The receiver needs to discard the content of the block, and if there is a complete block later, it is possible to continue to return data to the user.

In some embodiments, in the case of data expiration, if the data message is still not acknowledged for a period of time, it is possible to consider that the transmitted data segment of the stream is lost. At this time, an expire offset frame may be sent to inform the other party that some data of the stream is lost and is not retransmitted, and it is necessary to send the expire offset frame as soon as possible.

In other words, the sent data that is not acknowledged for a certain period of time may be considered to be lost. The unreliable implementation of the technical solution of the present disclosure is to inform the other party that the data is lost by sending an Expire Frame. The frame needs to be sent as soon as possible, and it is not ensured to be reliable.

In some embodiments, the expiration time may be a fixed value or set by a user through an application program. For example, with a fixed expiration time, it is also possible to use a callback to allow the user to decide how to expire. Regardless of the implementation by the application layer or the implementation by the protocol stack, each Boundary frame may be indexed.

In some embodiments, based on the QUIC transmission protocol, three common frames are added. The frame type requires IANA registration. These frames may be applied in the above-described process of transmission negotiation, data sending, data receiving and data expiration. The timeout period may be configured by the sender itself, and the timeout period may also be determined through negotiation.

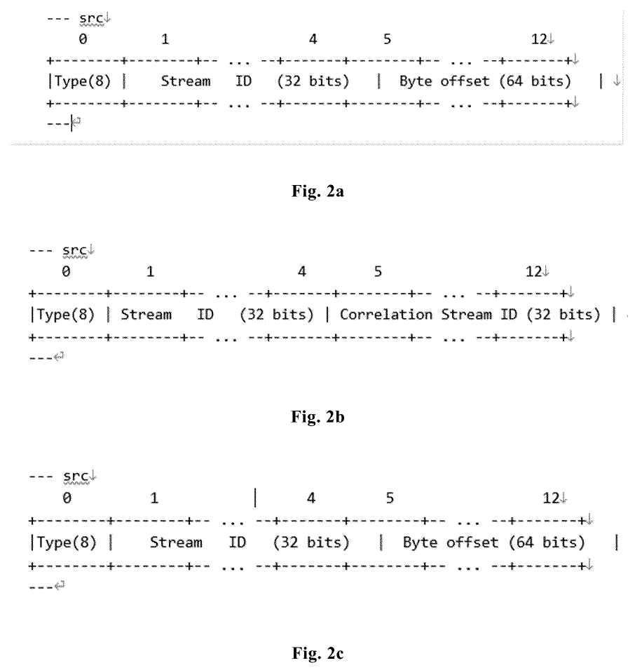

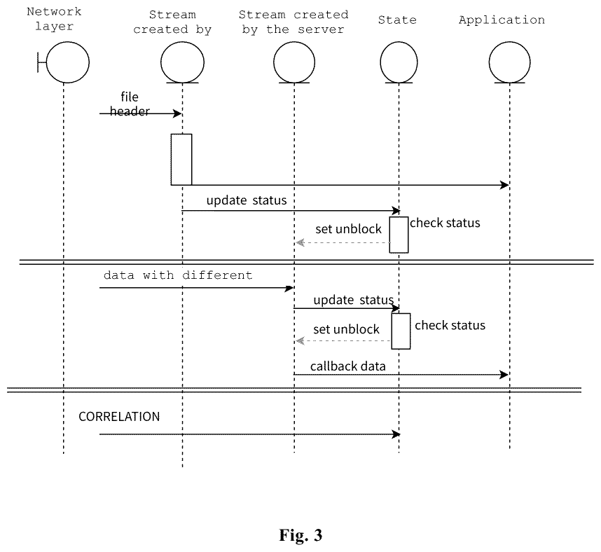

FIGS. 2a to 2c show schematic views of some embodiments of a frame structure according to the present disclosure.

As shown in FIG. 2a, the Boundary Frame comprises the following content.

The Stream ID is a common QUIC stream ID.

The Offset is the Stream ID's data offset, which indicates a position offset of the stream corresponding to the “Stream ID”. “offset” is an ending position of an independent data block, and a plurality of boundary frames constitute a plurality of independent discardable content blocks. The starting offset of the first boundary data received is 0.

In some embodiments, the Stream ID in the Boundary Frame is a stream ID that transmits the data block. The offset in the Boundary Frame corresponds to an ending position of the data block in the Stream. The starting and ending of a block may be determined by two blocks, and the starting position of the first block is 0 by default.

As shown in FIG. 2b, the Correlation Frame comprises the following content.

The Stream ID is a common QUIC stream ID.

The Correlation Stream ID, which is a common QUIC stream ID, is a stream ID of a request initiated by the client. The client delivers the data of a plurality of streams to the buffer called by the same application layer through the correlation frame.

As shown in FIG. 2c, the Expire Offset Frame comprises the following content.

The Stream ID is a common QUIC stream ID.

The Offset is the Stream ID's data offset, which indicates a position offset of the stream corresponding to the “Stream ID”. The data before “offset” is lost and the data is not retransmitted, and this offset is also a value of a boundary frame.

For example, the Stream ID of the Expire Offset Frame is configured to indicate a Stream on which an expiration operation is performed. The Offset is an offset of the Stream Data Frame, which means that the data before this offset is not retransmitted by the server.

In some embodiments, the objective of QUICU is to provide a controllable and unreliable data transmission capability for an application program, and the capability has two modes, comprising a single-stream mode and a multi-stream mode.

For example, in a single-stream mode, all types of data are divided by boundaries and transmitted in a single stream. If all types of data have the same expiration time, data may work very well. However, if different types of data have different timeout times (that is, expiration times), an expired frame might expire other data types that should not expire, so as to be affected by line congestion.

For example, in a multi-stream mode, different types of data may be put into different streams. These streams may be mapped to the same request stream through the correlation frame, so as to solve the problem of a single-stream mode. The whole data block of each stream should be delivered to a buffer of the application program before a data block of another stream can be delivered. If the data block of a stream is blocked upon delivery due to a buffer size, all the streams corresponding to the request should be blocked until the data may be delivered.

In some embodiments, the technical solution of the present disclosure may also comprise an error processing flow. If the receiver does not support the QUICU mode, but a boundary, expiree offset or correlation frame is received, the link should be closed and a mode of “not supporting QUICU” should be returned to.

FIG. 3 shows a schematic view of some embodiments of a data transmission method according to the present disclosure.

As shown in FIG. 3, a stream media application is transmitting HTTP (HyperText Transfer Protocol)-FLV (FLASH VIDEO) video data. Due to a real-time reason, it is necessary to transmit an audio and a video separately.

In some embodiments, two streams are created at the server for transmitting an audio and a video respectively, that is, “data with different priorities” in FIG. 3.

In some embodiments, the stream that receives a request is configured to make a http response, and the header information of the flv, that is, the “file header” in FIG. 3, is sent.

In some embodiments, the server first makes a response to a correlated header through the stream of the client, then creates the stream and sends the CORRELATION frame, and finally transmits the audio and video data. However, this process cannot ensure the sequence in which the data actually arrives at the client. Therefore, it is necessary to maintain their relationship with a state. Audio and video streams, that is, data with different priorities, and the file header are all controlled by a state, and are all in a blocking state under state control.

In some embodiments, after the CORRELATION frame is received, it is possible to act on state control. The state control sets the data with no priority indicated by the CORRELATION frame and the file header in a non-blocking state, that is, starting to send data to the application.

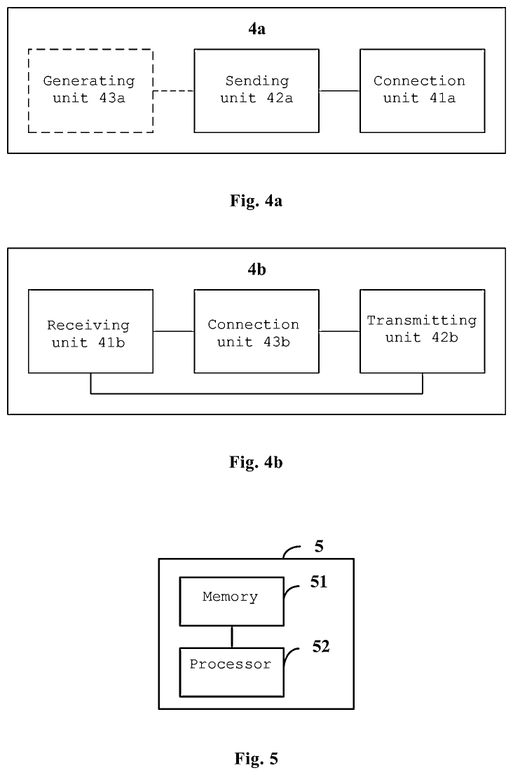

FIGS. 4a to 4b show block diagrams of some embodiments according to a data transmission device of the present disclosure.

As shown in FIG. 4a, the data transmission device 4a is arranged at a sender, and comprises: a connection unit 41a for establishing a connection with a receiver of data to be transmitted; and a sending unit 42a configured to transmit at least one of an expire offset frame for indicating data that is not retransmitted of data to be transmitted, a boundary frame for indicating a boundary position of a data block in a data stream of data to be transmitted, or a correlation frame for associating a plurality of data streams created based on the same request in data to be transmitted to a receiver, to allow the receiver to transmit data to be transmitted according to at least one of an expire offset frame, a boundary frame or a correlation frame.

In some embodiments, the transmission device 4a comprises a generating unit 43a for generating at least one of the expire offset frame, the boundary frame or the correlation frame.

In some embodiments, the expire offset frame comprises a first offset for indicating that data before the first offset relative to the expire offset frame in the data stream of the data to be transmitted is not retransmitted.

In some embodiments, the boundary position comprises an ending position, and the boundary frame comprises a second offset for indicating an ending position of the data block.

In some embodiments, the boundary frame is configured to save, in response to a data segment comprised in the data block being lost and not retransmitted, related information of a transmission for the data segment, related information of a retransmission for the data segment or related information of a retransmission request for the data segment.

In some embodiments, the boundary frame is configured to assign a same transmission priority to a plurality of data segments comprised in the data block.

In some embodiments, the same transmission priority is configured to indicate that another part of data segments in the data block is not retransmitted in response to a part of data segments in the data block being lost and not retransmitted.

In some embodiments, the correlation frame comprises a correlation stream ID, and each data stream of the plurality of data streams created based on the same request has a same correlation stream ID.

In some embodiments, a plurality of data streams associated with the correlation frame are presented together.

In some embodiments, the sending unit 42a confirms whether the receiver supports QUICU according to an identifier of the receiver when a connection is established. At least one of the expire offset frame, the boundary frame or the correlation frame is sent in response to the receiver supporting the QUICU.

As shown in FIG. 4b, the data transmission device 4b is arranged at a sender, and comprises: a connection unit 43b for establishing a connection with a sender of data to be transmitted; a receiving unit 41b configured to transmit at least one of an expire offset frame for indicating data that is not retransmitted of data to be transmitted, a boundary frame for indicating a boundary position of a data block in a data stream of data to be transmitted, or a correlation frame for associating a plurality of data streams created based on the same request in data to be transmitted to a sender; and a transmitting unit 42b configured to transmit data to be transmitted according to at least one of an expire offset frame, a boundary frame or a correlation frame.

FIG. 5 shows a block diagram of other embodiments of a data transmission device according to the present disclosure.

As shown in FIG. 5, the data transmission device 5 in this embodiment comprises: a memory 51; and a processor 52 coupled to the memory 51, wherein the processor 52 is configured to perform the data processing method according to any embodiment of the present disclosure based on the instructions stored in the memory 51.

Wherein, the memory 51 may comprise, for example, a system memory, a fixed non-volatile storage medium, or the like. The system memory stores, for example, an operation system, an application program, a boot loader, a database and other programs.

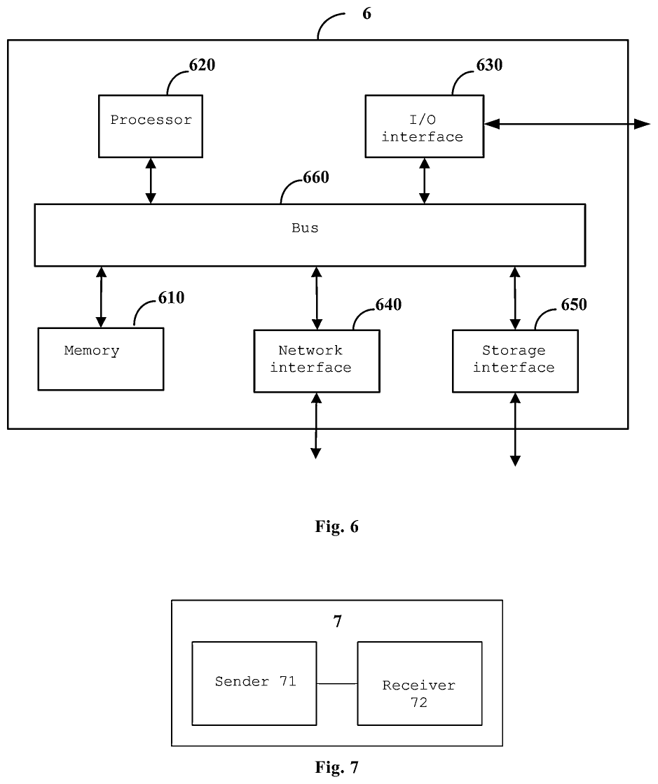

FIG. 6 shows a block diagram of still other embodiments of a data transmission device according to the present disclosure.

As shown in FIG. 6, the data transmission device 6 in this embodiment comprises: a memory 610; and a processor 620 coupled to the memory 610, wherein the processor 620 is configured to perform the data processing method according to any embodiment described previously based on the instructions stored in the memory 610.

The memory 610 may comprise, for example, a system memory, a fixed non-volatile storage medium, and the like. The system memory stores, for example, an operation system, an application program, a boot loader, and other programs.

The data transmission device 6 may further comprise an I/O interface 630, a network interface 640, a storage interface 650, and the like. These interfaces 630, 640, 650 as well as the memory 610 and the processor 620 therebetween may be connected, for example, via a bus 660. Wherein, the I/O interface 630 provides a connection interface for input and output devices such as a display, a mouse, a keyboard, a touch screen, a microphone and a speaker. The network interface 640 provides a connection interface for various networked devices. The storage interface 650 provides a connection interface for an external storage device such as an SD card or a USB flash disk.

FIG. 7 shows a block diagram of some embodiments of a data transmission system according to the present disclosure.

As shown in FIG. 7, the data transmission system 7 comprises: a sender 71 for performing a data transmission method on a sender side according to any of the above-described embodiments; and a receiver 72 for performing a data transmission method on a receiver side according to any of the above-described embodiments.

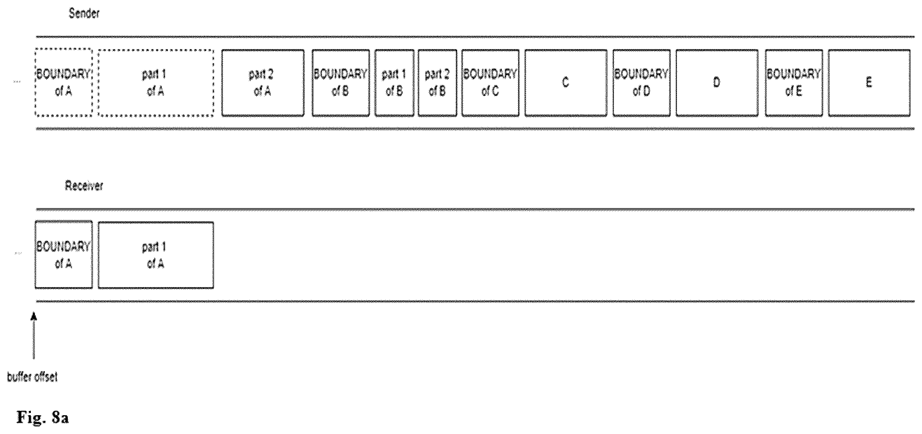

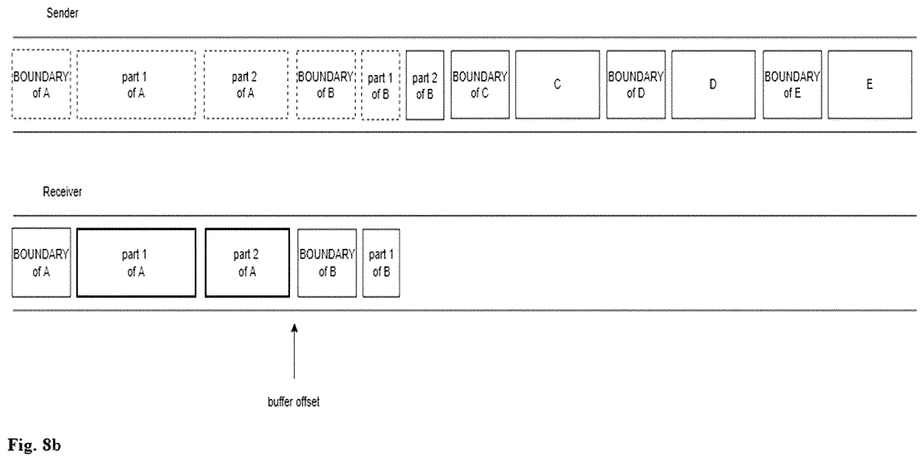

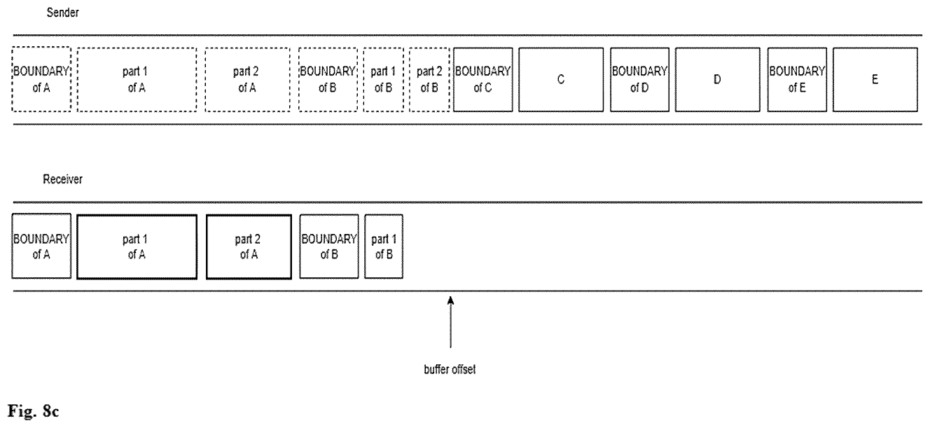

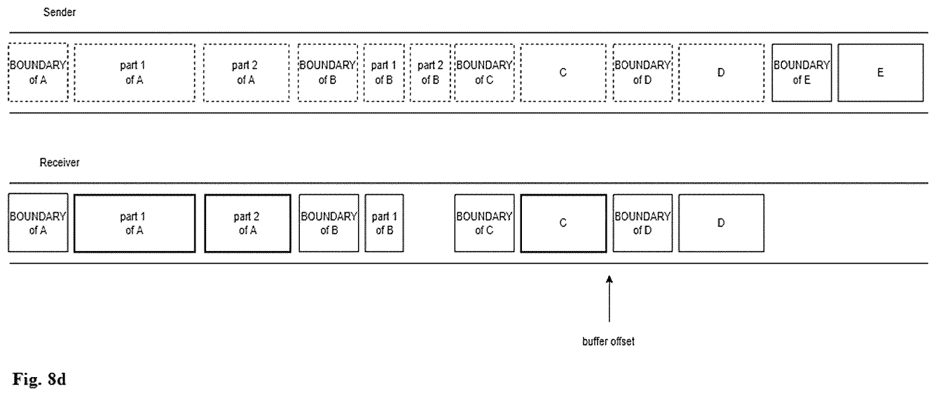

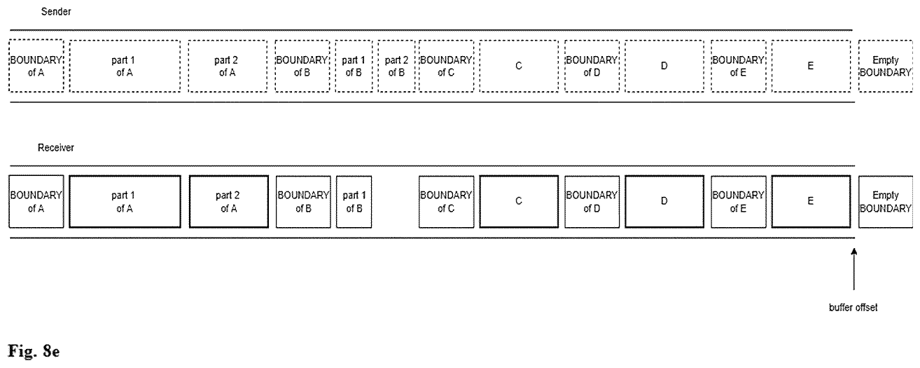

FIGS. 8a to 8e show schematic views of other embodiments of a data transmission method according to the present disclosure.

As shown in FIG. 8a, a stream media application which is transmitting video data, writes five FLV Video Tags to the unreliable stream of QUIC (all the stream data before A, B, C, D and E are delivered to the application layer, and for the sake of simplicity, this embodiments only represents one unreliable stream). QUIC generates a corresponding BOUNDARY frame each time the application writes. For example, the boundary frame is configured to indicate an initial position of a data block (for example, Tag A to E) in the data stream. Tag A is divided into part 1 and part 2 due to an excessive size, but QUIC ensures that the BOUNDARY frame of A and an initial part of A (for example, part 1 of Tag A) are transmitted in the same QUIC packet. At this time, the receiver receives the BOUNDARY frame of A and the initial part of A. However, it still cannot deliver A to the application at this time, because it still does not receive an adjacent next BOUNDARY frame.

Next, as shown in FIG. 8b, the receiver successively receives a remaining part of A (for example, part 2 of Tag A), the initial stream data of B (for example, part 1 of Tag B) and a corresponding BOUNDARY frame. Since the receiver receives two BOUNDARY frames, and the intermediate continuous content is received, and the previous data also is delivered, the receiver delivers A to the application layer.

For example, in the case where a boundary frame and a data segment between the boundary frame and a previous boundary frame are received by the receiver, the data segment between the boundary frame and the previous boundary frame is delivered to the application by the receiver.

Next, as shown in FIG. 8c, due to a packet loss, the remaining part of B is not acknowledged by the receiver, so that the sender decides to expire B initiatively, and the sender sends an EXPIRE_OFFSET frame (not shown, that is, an expire offset frame) at this time. After the EXPIRE_OFFSET frame is received, the receiver increases the minimum buffer offset of the received data to the position designated by the EXPIRE_OFFSET frame, also that is, the position where B ends. The receiver is informed by EXPIRE_OFFSET, so that the data segment before the offset of the EXPIRE_OFFSET is not retransmitted.

For example, in the case where the receiver does not acknowledge that a data block is received within a preset time, an expire offset frame is sent to the receiver.

Thereafter, as shown in FIG. 8d, the remaining data of B is not retransmitted by the sender, and the receiver receives the stream data and BOUNDARY frames of C and D. Since the BOUNDARY frames of C and D are received, the intermediate continuous data is received, and the previous data is expired, the receiver may deliver the stream data of C to the application (shown in bold).

Thereafter, as shown in FIG. 8e, the sender and the receiver sends/receives the remaining data completely. In order to ensure that the last segment of data E can be delivered, the sender sends an empty BOUNDARY frame before the ending to indicate that the data block is sent and received completely.

In some embodiments, if the semantic meaning of the BOUNDARY frame is changed so that the BOUNDARY frame's offset field indicates an ending position of a next segment of data, it is also possible to realize the unreliable transmission. For example, correspondingly, it is necessary to modify the strategy of reading data at the receiver. Under this semantic meaning, the receiver only needs one BOUNDARY frame to know an ending position of a segment of data, and the initial position may be calculated from the position of the BOUNDARY frame.

Those skilled in the art will appreciate that the embodiments of the present disclosure may be provided as a method, system, or computer program product. Therefore, the present disclosure may take the form of a hardware only embodiment, a software only embodiment, or an embodiment combining software and hardware aspects. Moreover, the present disclosure may take the form of a computer program product implemented in one or more computer-usable non-transitory storage media (comprising but not limited to a disk memory, CD-ROM, an optical memory, and the like) containing computer usable program codes therein.

Hereto, various embodiments according to the present disclosure have been described in detail. In order to avoid obscuring the concept of the present disclosure, some details commonly known in the art have not been described. From the above descriptions, those skilled in the art may fully understand how to implement the technical solutions disclosed here.

The method and system of the present disclosure might be implemented in many methods. For example, the method and system of the present disclosure may be implemented by software, hardware, firmware, or any combination of software, hardware, and firmware. The above-described sequence for the steps of the above-described method is merely for an illustrative purpose, and the steps of the method of the present disclosure are not limited to the sequence specifically described above unless specified otherwise. Moreover, in some embodiments, the present disclosure may also be embodied as programs recorded in a recording medium, which comprise machine readable instructions for implementing the method according to the present disclosure. Accordingly, the present disclosure also covers a recording medium that stores programs for performing the method according to the present disclosure.

Although some specific embodiments of the present disclosure have been described in detail by way of examples, those skilled in the art should understand that the above examples are only for an illustrative purpose, rather than limiting the scope of the present disclosure. Those skilled in the art should appreciate that modifications to the above-described embodiments may be made without departing from the scope and spirit of the present disclosure. The scope of the present disclosure is defined by the appended claims.

What is claimed is:

1. A data transmission method, comprising:
establishing a connection with a receiver of data to be transmitted; and
sending at least one of an expire offset frame for indicating data that is not retransmitted of data to be transmitted, a boundary frame for indicating a boundary position of a data block in a data stream of the data to be transmitted, or a correlation frame for associating a plurality of data streams created based on a same request of the data to be transmitted to the receiver, to allow the receiver to transmit the data to be transmitted according to the at least one of the expire offset frame, the boundary frame, or the correlation frame.

2. The data transmission method according to claim 1, wherein the expire offset frame comprises a first offset for indicating that data before the first offset relative to the expire offset frame in the data stream of the data to be transmitted is not retransmitted.

3. The data transmission method according to claim 1, wherein the boundary position comprises an ending position, and the boundary frame comprises a second offset for indicating the ending position of the data block.

4. The data transmission method according to claim 1, wherein the boundary frame is configured to save, in response to a data segment comprised in the data block being lost and not retransmitted, related information of a transmission for the data segment, related information of a retransmission for the data segment or related information of a retransmission request for the data segment.

5. The data transmission method according to claim 1, wherein the boundary frame is configured to assign a same transmission priority to a plurality of data segments comprised in the data block.

6. The data transmission method according to claim 5, wherein the same transmission priority is configured to indicate that in response to a part of data segments in the data block being lost and not retransmitted, another part of data segments in the data block is not retransmitted.

7. The data transmission method according to claim 1, wherein the correlation frame comprises a correlation stream ID, and each data stream of the plurality of data streams created based on the same request has a same correlation stream ID.

8. The data transmission method according to claim 1, wherein the plurality of data streams associated with the correlation frame are presented together.

9. The data transmission method according to claim 1, further comprising:
determining, in response to the connection being established, whether the receiver supports an extended Quick UDP Internet Connection (QUICU) according to an identifier of the receiver,
wherein at least one of the expire offset frame, the boundary frame or the correlation frame is sent in response to the receiver supporting the QUICU.

10. A data transmission method, comprising:
establishing a connection with a sender of data to be transmitted;
receiving at least one of an expire offset frame for indicating data that is not retransmitted of data to be transmitted, a boundary frame for indicating a boundary position of a data block in a data stream of the data to be transmitted, or a correlation frame for associating a plurality of data streams created based on a same request of the data to be transmitted that is transmitted by the sender; and
transmitting the data to be transmitted according to at least one of the expire offset frame, the boundary frame, or the correlation frame.

11. The data transmission method according to claim 10, further comprising:
transmitting an identifier to the sender, which is for identifying whether a receiver of the data to be transmitted supports an extended Quick UDP Internet Connection (QUICU), in response to the connection being established,
wherein at least one of the expire offset frame, the boundary frame or the correlation frame is sent in response to the receiver supporting the QUICU.

12. A data transmission system, comprising:
a sender configured to perform a data transmission method, comprising:
establishing a connection with a receiver of data to be transmitted; and
sending at least one of an expire offset frame for indicating data that is not retransmitted of data to be transmitted, a boundary frame for indicating a boundary position of a data block in a data stream of the data to be transmitted, or a correlation frame for associating a plurality of data streams created based on a same request of the data to be transmitted to the receiver, to allow the receiver to transmit the data to be transmitted according to the at least one of the expire offset frame, the boundary frame, or the correlation frame; and
a receiver configured to perform the data transmission method according to claim 10.

13. A data transmission device, comprising:
a memory; and
a processor coupled to the memory, wherein the processor is configured to perform, based on instructions stored in the memory, the data transmission method according to claim 10 or a data transmission method, comprising:
establishing a connection with a receiver of data to be transmitted; and
sending at least one of an expire offset frame for indicating data that is not retransmitted of data to be transmitted, a boundary frame for indicating a boundary position of a data block in a data stream of the data to be transmitted, or a correlation frame for associating a plurality of data streams created based on a same request of the data to be transmitted to the receiver, to allow the receiver to transmit the data to be transmitted according to the at least one of the expire offset frame, the boundary frame, or the correlation frame.

14. The data transmission device according to claim 13, wherein the expire offset frame comprises a first offset for indicating that data before the first offset relative to the expire offset frame in the data stream of the data be transmitted is not retransmitted.

15. The data transmission device according to claim 13, wherein the boundary position comprises an ending position, and the boundary frame comprises a second offset for indicating the ending position of the data block.

16. The data transmission device according to claim 13, wherein the boundary frame is configured to save, in response to a data segment comprised in the data block being lost and not retransmitted, related information of a transmission for the data segment, related information of a retransmission for the data segment or related information of a retransmission request for the data segment.

17. The data transmission device according to claim 13, wherein the boundary frame is configured to assign a same transmission priority to a plurality of data segments comprised in the data block.

18. The data transmission device according to claim 17, wherein the same transmission priority is configured to indicate that in response to a part of data segments in the data block being lost and not retransmitted, another part of data segments in the data block is not retransmitted.

19. The data transmission device according to claim 13, wherein the correlation frame comprises a correlation stream ID, and each data stream of the plurality of data streams created based on the same request has a same correlation stream ID.

20. A nonvolatile computer readable storage medium, having a computer program stored thereon that, when executed by a processor, implements the data transmission method according to claim 10 or a data transmission method, comprising:
establishing a connection with a receiver of data to be transmitted; and
sending at least one of an expire offset frame for indicating data that is not retransmitted of data to be transmitted, a boundary frame for indicating a boundary position of a data block in a data stream of the data to be transmitted, or a correlation frame for associating a plurality of data streams created based on a same request of the data to be transmitted to the receiver, to allow the receiver to transmit the data to be transmitted according to the at least one of the expire offset frame, the boundary frame, or the correlation frame.
